(19) United States
(12) Patent Application Publication
(10) Pub. No.: US 2026/0098767 A1
(43) Pub. Date: Apr. 9, 2026

(54) Data Acquisition for Rotating Machines

(71) Applicant: OHIO STATE INNOVATION FOUNDATION, Columbus, OH (US)

(72) Inventor: Isaac Hong, Columbus, OH (US)

(21) Appl. No.: 19/354,236

(22) Filed: Oct. 9, 2025

Related U.S. Application Data
(60) Provisional application No. 63/705,237, filed on Oct. 9, 2024.

(51) Int. Cl. G01L 1/22

(52) U.S. Cl. CPC G01L 1/225

(57) ABSTRACT

An example implementation of the present disclosure includes a data acquisition system for rotating machines including a microcontroller; and a first sensor operably coupled to the microcontroller, where the first sensor and the microcontroller are configured to be fixed to a rotating machine. Example implementations further include more than one sensor, including MEMS accelerometers, piezoelectric sensors, removable memories, analog/digital strain gauges, multiple channel analog-digital converters, and packaging configured to affix the data acquisition system to the rotating machine and/or cool the data acquisition system.

### CROSS-REFERENCE TO RELATED APPLICATIONS

This application claims the benefit of U.S. provisional patent application No. 63/705,237, filed on October 9, 2024, and titled “Data Acquisition for Rotating Machines,” the disclosure of which is expressly incorporated herein by reference in its entirety.

### BACKGROUND

Rotating machines include motors, generators, and actuators. Rotating machines can be complicated mechanical systems. For example, increasing the power delivered to a motor can increase the speed of the motor shaft, which can result in vibrations/oscillations at different harmonics as the speed of the motor shaft increases. There are benefits to measuring the vibration, speed, acceleration, and other physical parameters of rotating machinery to characterize mechanical systems. A common way that such measurements are taken is using a slip ring, which is a type of rotating electrical connection that can be used to connect a sensor on a rotating machine to a stationary data logger for recording, control and/or analysis.

### SUMMARY

In some aspects, implementations of the present disclosure include a data acquisition system including: a microcontroller; and a first sensor operably coupled to the microcontroller; wherein the first sensor and the microcontroller are configured to be fixed to a rotating machine, and wherein the microcontroller is configured to record sensor data from the first sensor during the operation of the rotating machine.

In some aspects, implementations of the present disclosure include a data acquisition system, further including an amplifier operably coupled between the first sensor and the microcontroller.

In some aspects, implementations of the present disclosure include a data acquisition system, further including a conditioner operably coupled between the first sensor and the microcontroller.

In some aspects, implementations of the present disclosure include a data acquisition system, wherein the conditioner includes an analog strain conditioner.

In some aspects, implementations of the present disclosure include a data acquisition system, further including an LED operably coupled to the microcontroller, wherein the microcontroller is configured to control the LED based on the sensor data.

In some aspects, implementations of the present disclosure include a data acquisition system, wherein the microcontroller includes an analog-to-digital converter configured to sample an output of the first sensor.

In some aspects, implementations of the present disclosure include a data acquisition system, wherein the analog-to-digital converter is configured to sample the output of the first sensor at a rate of 350000 samples per second or greater.

In some aspects, implementations of the present disclosure include a data acquisition system, further including a second sensor operably coupled to the microcontroller.

In some aspects, implementations of the present disclosure include a data acquisition system, wherein the microcontroller includes a dual-channel ADC with a first channel and a second channel, and wherein the first channel is operably coupled to the first sensor and the second channel is operably coupled to the second sensor.

In some aspects, implementations of the present disclosure include a data acquisition system, wherein the dual-channel ADC is configured to simultaneously sample both the first channel and second channel at a rate of 300000 samples per second or greater.

In some aspects, implementations of the present disclosure include a data acquisition system, wherein the first sensor or the second sensor include a strain gauge.

In some aspects, implementations of the present disclosure include a data acquisition system, wherein the first sensor or the second sensor include an analog strain gauge.

In some aspects, implementations of the present disclosure include a data acquisition system, wherein the first sensor or the second sensor include a thermocouple.

In some aspects, implementations of the present disclosure include a data acquisition system, wherein the first sensor or the second sensor include a MEMS accelerometer or a piezoelectric sensor.

In some aspects, implementations of the present disclosure include a data acquisition system, further including a removable memory operably coupled to the microcontroller.

In some aspects, implementations of the present disclosure include a data acquisition system, further including a package covering at least a part of the microcontroller and configured to affix the microcontroller to the rotating machine.

In some aspects, implementations of the present disclosure include a data acquisition system, wherein the package is configured to cool the microcontroller.

In some aspects, implementations of the present disclosure include a data acquisition system, wherein the microcontroller is configured to adjust a sampling rate, and/or recording rate of the data acquisition system based on a temperature of the microcontroller and/or a speed of the rotating machine.

In some aspects, implementations of the present disclosure include a system including: a microcontroller; and a remote computing device; a first sensor operably coupled to the microcontroller; wherein the first sensor and the microcontroller are configured to be fixed to a rotating machine, and wherein the microcontroller is in operative communication with the remote computing device and configured to transmit sensor data from the first sensor during the operation of the rotating machine.

In some aspects, implementations of the present disclosure include a system, further including a slip ring coupling the remote computing device and the microcontroller.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates an example data acquisition system configured to measure a rotating machine, according to implementations of the present disclosure.

FIG. 1B illustrates an example data acquisition system configured to measure a rotating machine including a flexible PCB, according to implementations of the present disclosure.

FIG. 1C illustrates an example data acquisition system configured to measure a rotating machine including a flexible PCB and indicator light, according to implementations of the present disclosure.

FIG. 1D illustrates a structural encasement and mount that can be used to attach the systems of FIGS. 1A-1C to a rotating shaft, according to implementations of the present disclosure.

FIG. 2A illustrates an example data acquisition system including a strain gauge, battery, and amplifier and conditioner, according to implementations of the present disclosure.

FIG. 2B illustrates an example data acquisition system including a strain gauge, slip ring, and amplifier and conditioner, according to implementations of the present disclosure.

FIG. 3 illustrates an example computing device.

FIG. 4A illustrates an example perspective view of a text fixture used in a study of an example implementation of the present disclosure.

FIG. 4B illustrates an example schematic of the fixture shown in FIG. 4A.

FIG. 4C illustrates an example cross-sectional view of the schematic shown in FIG. 4B.

FIG. 5 illustrates example experimental results comparing an example implementation of the present disclosure to a conventional “benchmark” system.

FIG. 6A illustrates an example implementation of the present disclosure configured with a slip ring.

FIG. 6B illustrates an example implementation of the present disclosure without a slip ring.

FIG. 7 illustrates an example strain conditioner circuit.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from "about" one particular value, and/or to "about" another particular value. When such a range is expressed, an aspect includes from the one particular value and/or to the other particular value. Similarly, when values are expressed as approximations, by use of the antecedent "about," it will be understood that the particular value forms another aspect. It will be further understood that the endpoints of each of the ranges are significant both in relation to the other endpoint, and independently of the other endpoint. While implementations will be described for strain sensing, it will become evident to those skilled in the art that the implementations are not limited thereto, but are applicable for other types of sensing.

Implementations of the present disclosure include systems, devices, and methods that can be used to measure rotational motion. In both lab/test and industrial environments, measuring rotating equipment requires either the use of an electrical slip ring or wireless telemetry to pull the data signal to stationary data acquisition and data logging equipment. Both options add immense capital expenses and hit limitations in speed and size quickly. Additionally, using slip rings for data transmission can be unreliable, as the electrical properties of the slip ring can be dynamic and therefore affect the reliability of data transmitted over the slip ring.

Implementations of the present disclosure include improvements to sensing for rotating electrical machines that can be used in industry (power transmission, gearing, turbines, shafts) and for research. For example, implementations of the present disclosure can be used to perform data gathering, validate predictive models of mechanical behavior, benchmark prototype capabilities, and/or measure mechanical response of systems (e.g., to control inputs). Another advantage of implementations of the present disclosure is the small size of the example implementations, enabled by the use of miniature microcontrollers and circuits configured for use with miniature microcontrollers. Conventional microcontrollers used for instrumentation purposes may be on the order of 49-70 cubic centimeters when installed on a PCB, preventing them from being installed on the shafts of many rotating machines. The present disclosure includes systems configured for miniature microcontrollers that can be about 4-7 cubic centimeters, allowing them to be installed on rotating shafts. Additionally, the present disclosure contemplates the use of miniature microcontrollers with high sampling rates (e.g., about 450 kHz sampling or greater in some implementations ) to enable real-time data logging and processing on the rotating shaft (which can be referred to herein as “edge computing”).

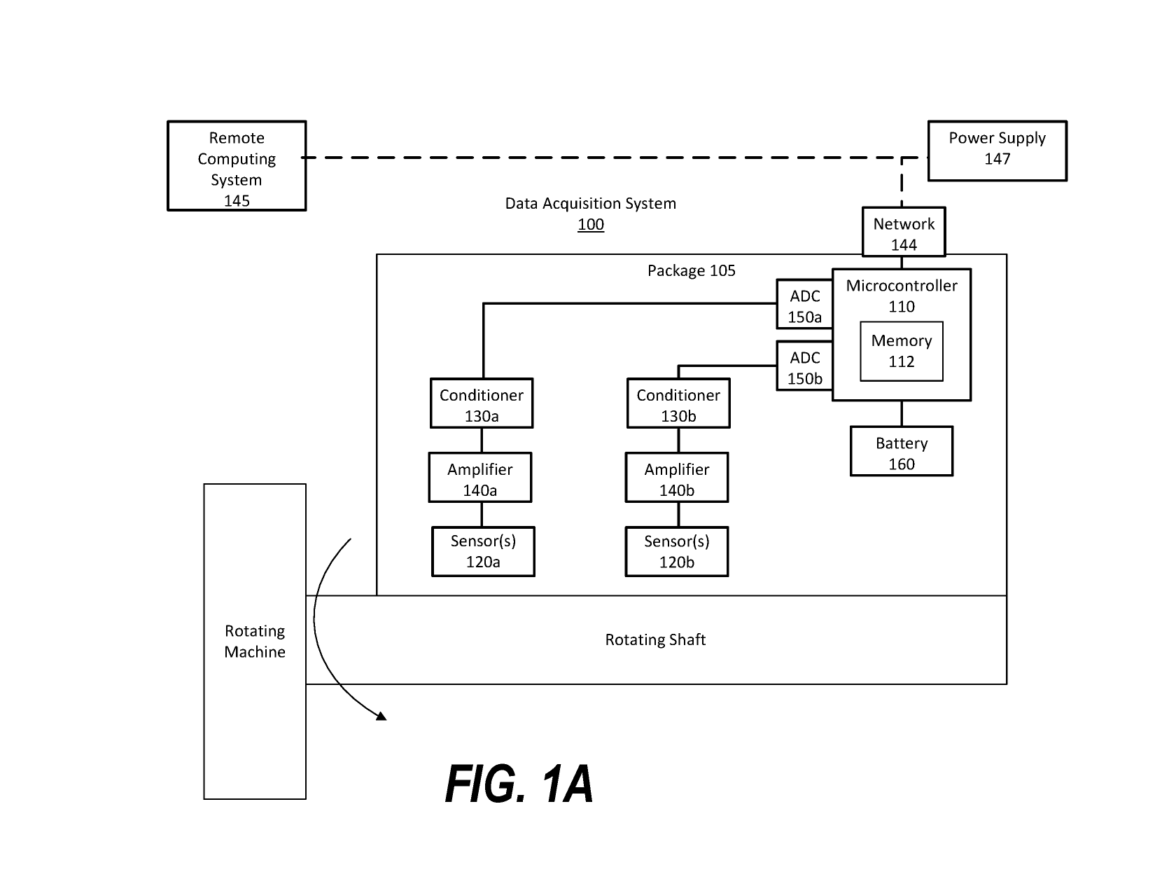

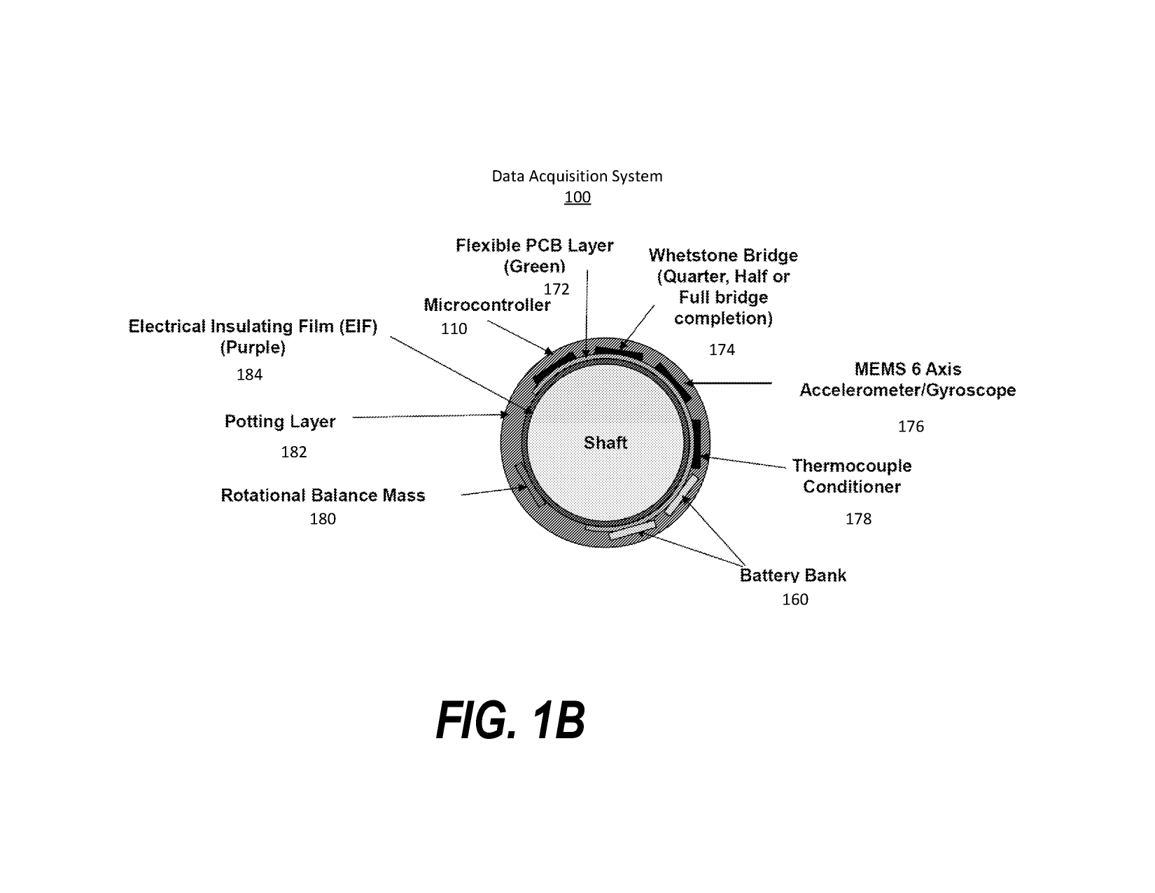

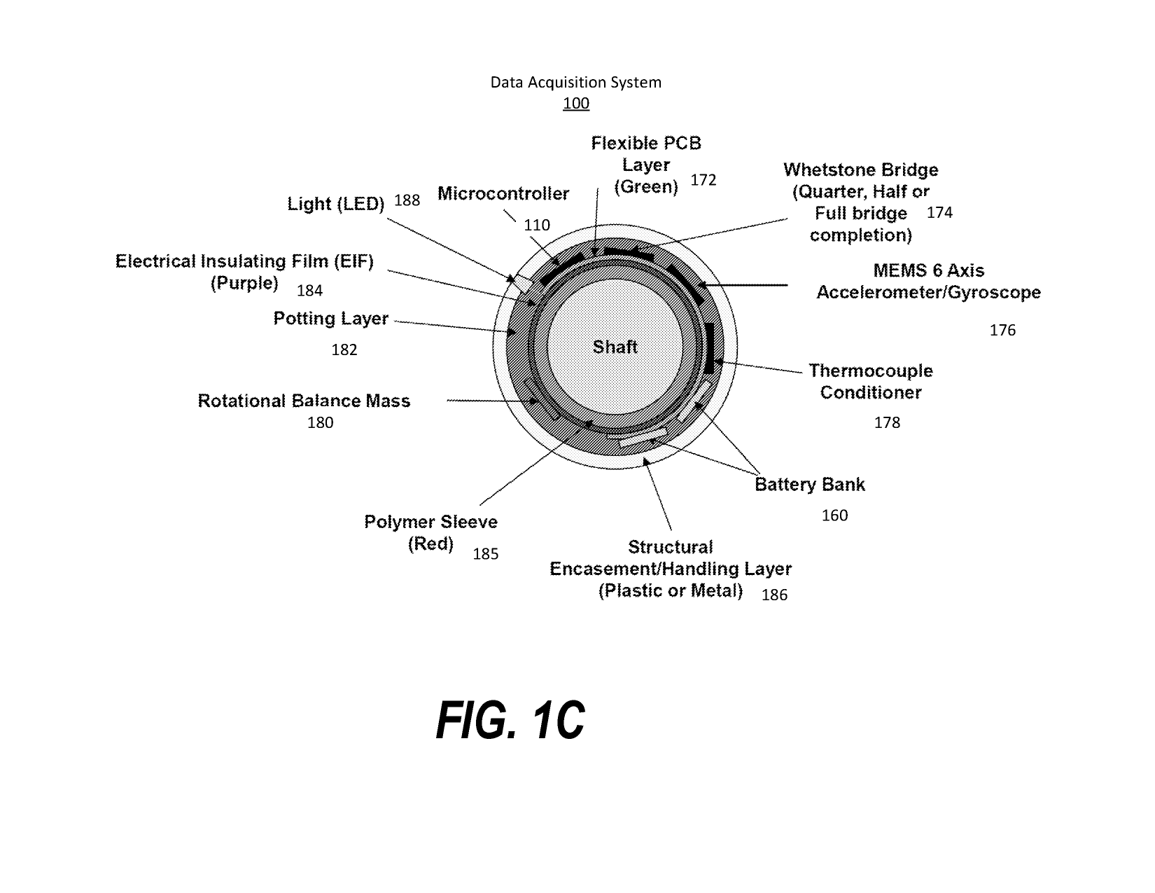

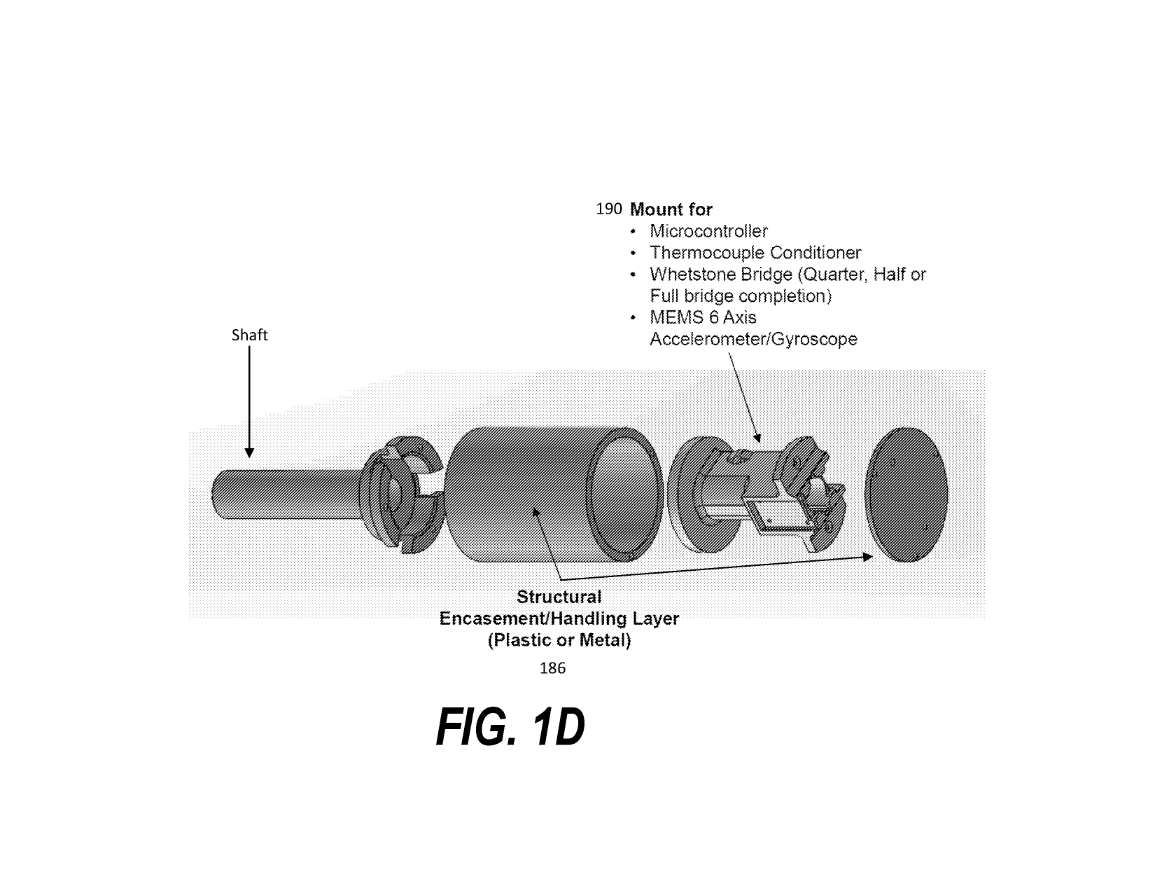

With reference to FIG. 1A, an example implementation of the present disclosure is configured as a data acquisition system 100 for a shaft of a rotating machine (e.g., a motor, generator, actuator, and/or any other machine with a rotating component). The data acquisition system 100 includes a microcontroller 110 and one or more sensors 120a, 120b.

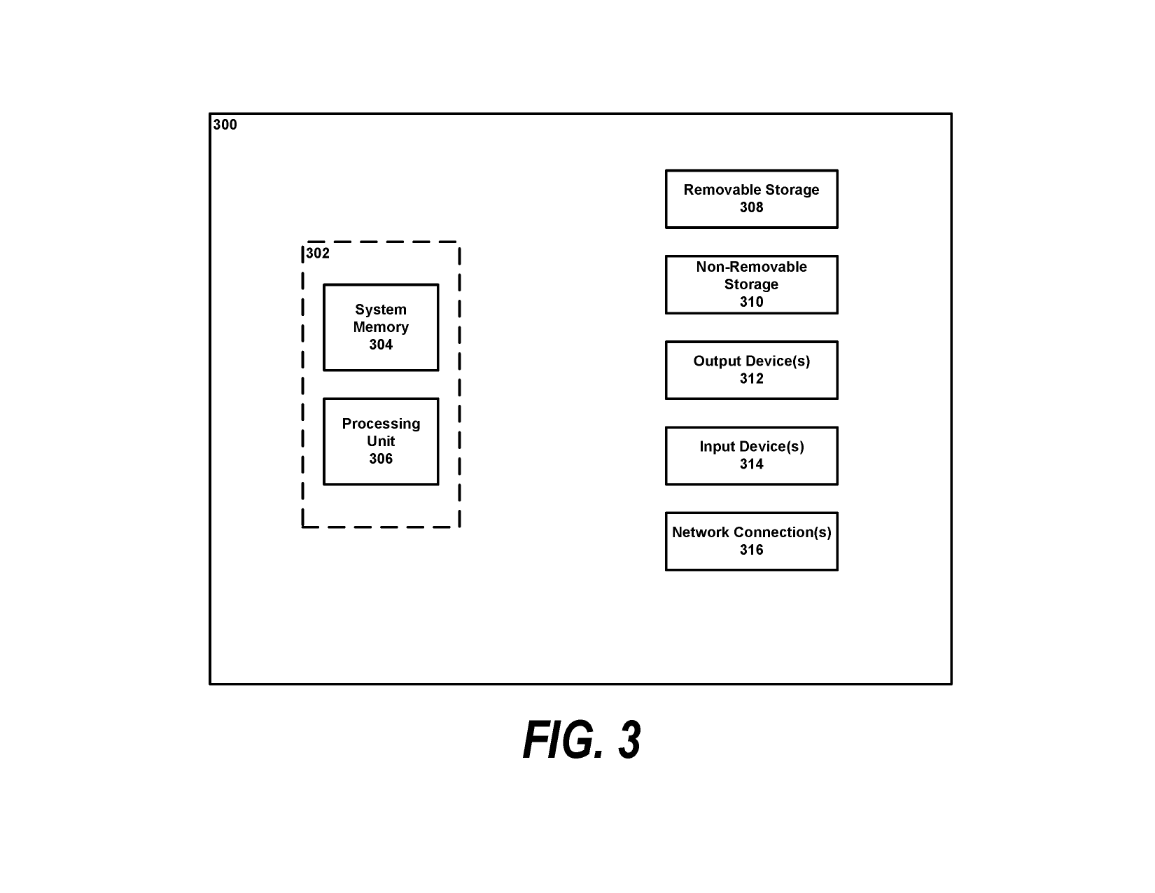

The microcontroller 110 can include any or all of the features of the computing device 300 described with reference to FIG. 3. The microcontroller 110 can be in operative communication with the sensors 120a, 120b and configured to record signals received from the sensor(s) 120a, 120b in a memory 112 (e.g., the removable storage 310 or system memory 304 described with reference to FIG. 3). Optionally, the microcontroller 110 can include one or more analog-to-digital converter(s) 150a, 150b, signal processing/conditioning circuit(s), and/or amplifier(s) configured to process signals from the one or more sensors 120a, 120b before the signals are recorded. An example microcontroller can include two or more analog-to-digital converters, with a 10-bit resolution (e.g., 0.003 V), which can allow for .15 MPa precision or ~0.8 με precision. Another example of a microcontroller that can be used includes a 16-bit ADC with 30,000 samples/second/channel. This can correspond to 65,536 levels on a +/- 10 V input, for 0.0003 V resolution. An example strain conditioner circuit that can be used for data acquisition is shown in FIG. 7, which illustrates a strain Wheatstone bridge with level shifter and simulated input output. The example circuit can be used to verify the strain amplification and level shifting (e.g., by rescaling the voltage output) circuit for computer-aided simulation of circuit response.

The microcontroller 110 can optionally be a microcontroller configured for high rates of data acquisition and/or sampling. For example, the analog-to-digital converters 150a, 150b can be configured to sample the first sensor 120a and/or second sensor 120b at a rate of 350000 samples per second or greater. As another non-limiting example, if the analog-to-digital converters 150a, 150b are configured as a dual-channel analog-to-digital converter, the dual-channel analog-to-digital converter can optionally be configured to simultaneously sample both the first channel and second channel at a rate of 300000 samples per second or greater.

The sensors 120a, 120b can be any type of sensors. Non-limiting examples of sensors that can be used as either or both sensors 120a, 120b include: strain gauges (analog or digital); thermocouples; accelerometers (e.g., microelectromechanical (MEMS) accelerometers); piezoelectric sensors (e.g., force/vibrational sensors); and any other mechanical sensor. Herein, the analog and/or digital measurements of the sensors 120a, 120b can be referred to as “sensor data.”

In some implementations, only a single sensor 120a is used. In other implementations, any number of sensors can be used so that there can be more than the two sensors 120a, 120b shown in FIG. 1A. Additionally, it should be understood that any different combinations of sensors are possible.

Alternatively or additionally, discrete signal conditioner circuit(s) 130a, 130b can be operably coupled between the sensor(s) and microcontroller 110, as shown in FIG. 1A. As a non-limiting example, the discrete signal conditioner circuits 130a, 130b can include analog strain conditioner circuits.

Alternatively or additionally, discrete amplifier circuit(s) 140a, 140b can be operably coupled between the sensors 120a, 120b, and the microcontroller 110.

While FIG. 1A illustrates two sensors 120a, 120b that are coupled to the microcontroller through respective discrete amplifier circuit(s) 140a, 140b and discrete signal conditioner circuit(s) 130a, 130b, it should be understood that any number of sensors 120a, 120b, discrete amplifier circuit(s) 140a, 140b, and/or discrete signal conditioner circuit(s) 130a, 130b can be used in different combinations. It should also be understood that the sensors 120a, 120b, discrete amplifier circuit(s) 140a, 140b, and discrete signal conditioner circuit(s), 130a, 130b can be coupled in different sequences/combinations.

Still with reference to FIG. 1A, the data acquisition system 100 can optionally include a battery 160 configured to power any/all of the data acquisition system 100. For example, the battery 160 can be configured to power the sensors 120a, 120b, and/or the microcontroller 110. Alternatively or additionally, the data acquisition system 100 can include a slip ring (not shown) configured to power the data acquisition system 100 and/or recharge the battery. Using a slip ring to power the system provides an improvement over conventional designs where the slip ring is used to read the sensors, as slip rings exhibit changes in impedance as they rotate that can disrupt sensor readings. These changes in impedance may be less likely to disrupt less-sensitive power signals.

Still with reference to FIG. 1A, the data acquisition system 100 can be configured to be affixed to a rotating shaft of a rotating machine. The data acquisition system can include a package 105 (e.g., potting) configured to protect any/all of the components of the data acquisition system 100 from oil, moisture, dust, and similar contaminates that are commonly found inside rotating machines.

Optionally, the package 105 can include features to cool the microcontroller 110 (e.g., using the airflow from inside the rotating machine). The microcontroller 110 can be configured to adjust the sampling rate based on the temperature of the microcontroller 110 and/or any other part of the data acquisition system 100. The microcontroller 110 can be configured to increase the sampling frequency of the analog-to-digital converters 150a, 150b, which can increase heat generated by the microcontroller 110. Alternatively or additionally, the microcontroller 110 can be configured to adjust the sampling rate based on the speed of the rotating machine and/or rotating shaft, by increasing the sampling rate as the speed increases. Higher rotational speeds can require higher data sampling rates to characterize, and high rotational speeds can also generate more cooling for the data acquisition system 100. Thus, the present disclosure contemplates that the microcontroller 110 can be configured to balance data acquisition speed with cooling to accurately measure the rotating machine.

Still with reference to FIG. 1A, the data acquisition system 100 can be in operative communication with a remote computing device 145, so that sensor data can be transmitted to the remote computing device 145. Optionally, sensor data can be transmitted to the remote computing device 145 as an alternative to storing sensor data in the memory 112 of the data acquisition system 100. A power supply 147 can also be in operative communication with the microcontroller 110 in some implementations. The power supply 147 can be an alternative to the battery 160, or in addition to the battery 160.

Both the power supply 147 and remote computing device 145 can be in operative communication with the microcontroller 110 through a network 144. The network 144 can optionally be implemented using a slip ring to provide a direct electrical connection between the rotating shaft and the remote computing device 145 and power supply 147 that may not be on the rotating shaft. Alternatively or additionally, the network 144 can be implemented using a wireless connection (e.g., WiFi, Bluetooth, ultra-wideband, etc.). The network 144 can optionally include wireless power delivery features. As described herein, some implementations of the present disclosure do not include a network 144, and therefore can operate by recording to a memory 112 that can optionally be removable.

FIG. 1B illustrates an example implementation of the system shown in FIG. 1A. As shown in FIG. 1B, the microcontroller 110 can optionally be mounted to a flexible PCB 172 (printed circuit board) that is disposed around the shaft. The data acquisition system 100 can further include a Wheatstone bridge 174 or other measurement circuit configured to measure a strain gauge (not shown). The microcontroller 110 can be configured to measure the strain gauge using the Wheatstone bridge 174.

The data acquisition system 100 can optionally include an accelerometer o gyroscope 176, which can be a MEMS in some implementations. The data acquisition system 100 can also optionally include a thermocouple 178, which can optionally include a thermocouple conditioner circuit. The thermocouple 178 can optionally be replaced with any temperature sensor, and the accelerometer or gyroscope 176 can optionally include an accelerometer only, a gyroscope only, or both. Optionally, the accelerometer or gyroscope 176 can be an integrated inertial measurement unit that includes features of an accelerometer and gyroscope.

The accelerometer or gyroscope 176 and/or thermocouple 178 can be in operative communication with the microcontroller 110, which can be configured to receive/record measurements from the whetstone bridge (e.g., resistance measurements corresponding to strain gauge measurements), accelerometer or gyroscope (e.g., acceleration and/or rotation measurements), and/or the thermocouple 178 (e.g., temperature measurements). In some implementations, the data acquisition system 100 can be provided without the accelerometer or gyroscope 176 or thermocouple 178 to allow for a user to install any accelerometer or gyroscope 176 or thermocouple 178. In such implementations, the data acquisition system 100 can optionally be provided with circuits configured to read an accelerometer or gyroscope 176 or thermocouple 178 (e.g., analog amplifier or conditioning circuits, multiplexers, etc.).

With reference to FIG. 1C, implementations of the present disclosure can further include features configured to output a status of a rotating machine, as well as additional features for mounting circuitry to rotating shafts. FIG. 1C illustrates the data acquisition system 100 described in FIG. 1B. An LED 188 is added, operably connected to the microcontroller 110 to enable the microcontroller 110 to output a status of the rotating shaft. For example, the microcontroller can use integrated digital signal processing via a combination or selection of frequency domain analysis, cepstral editing, wavelet transform and/or machine learning algorithms to detect when speed, vibration, acceleration, or another parameter is within or outside of a predetermined range and display the status of the rotating shaft using the LED. For example, the LED 188 can be a multicolor LED with different colors corresponding to different statuses of the shaft. Other types of light sources or indicators can be used in addition to, or in alternative to, LEDs.

Any of the components in FIGS. 1A-1C can be partially or completely encapsulated by an electrically insulating film 184 or other protective layer as shown in FIGS. 1B and 1C. For example, the components of the data acquisition system 100 (e.g., the flexible PCB 172) can be insulated from the shaft by the electrically insulating film 184. The electrically insulating film 184 can optionally be separated from the shaft by a polymer sleeve 185 disposed over the shaft. Alternatively or additionally, any or all of the components shown can be partially or completely encapsulated in a potting layer 182 to protect them from dust, moisture, debris, etc. A rotational balance mass 180 can be added to the data acquisition system 100 to provide a counterweight to any or all of the other components.

FIG. 1D illustrates an example structural encasement 186 and mount 190 that can be used to affix implementations of the present disclosure to the shaft. The structural encasement 186 can be plastic and/or metal, and can be configured to surround the mount 190 completely or partially. The mount 190 can optionally be configured to attach to the microcontroller 110, thermocouple 178 (and/or thermocouple conditioner), whetstone bridge 174, and/or accelerometer or gyroscope 176 described with reference to FIGS. 1A-1C.

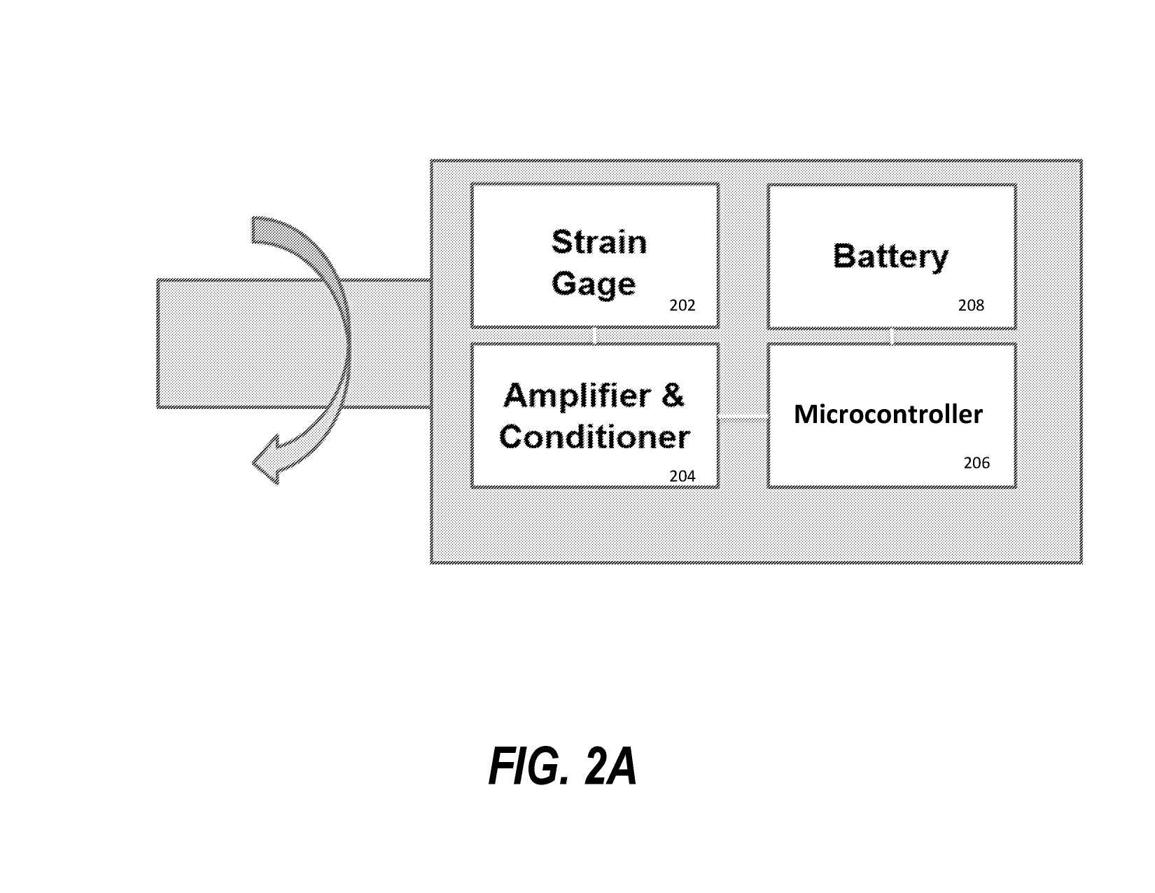

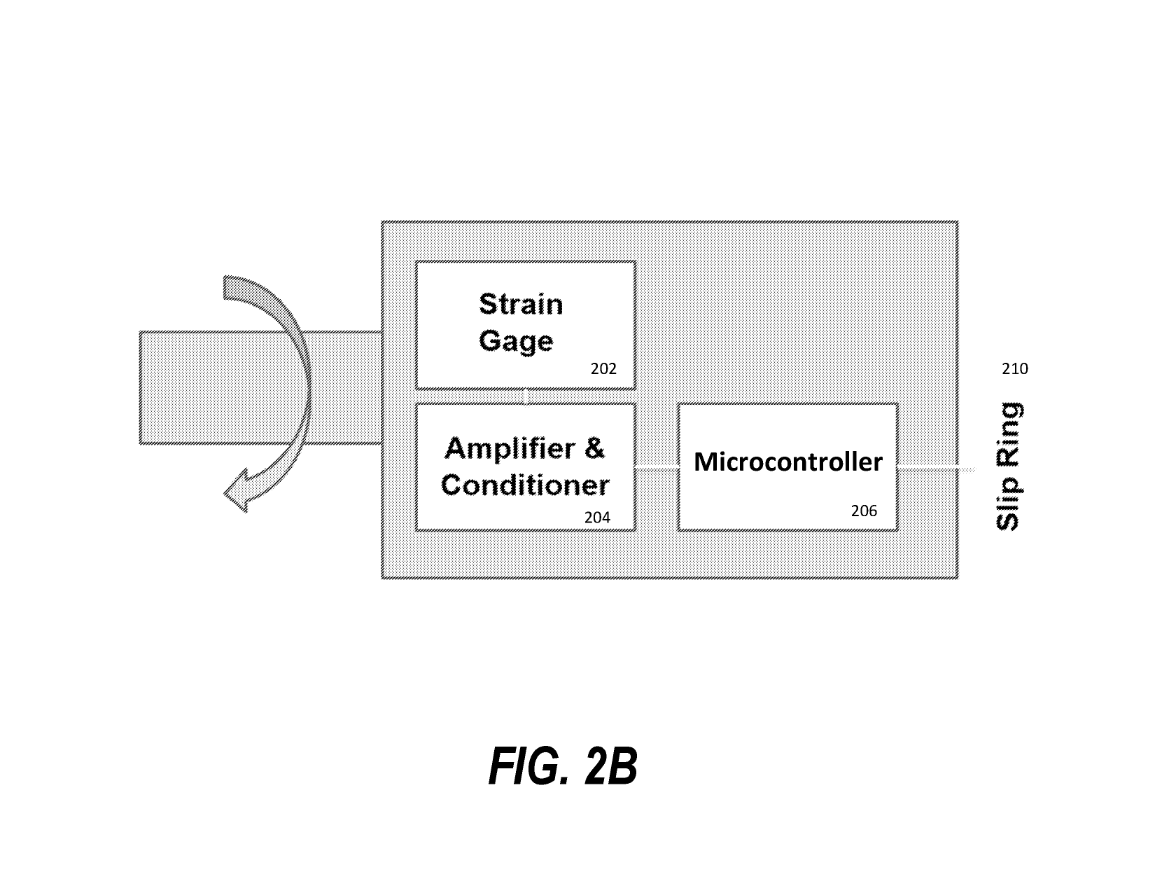

FIG. 2A and FIG. 2B illustrate example implementations of the present disclosure configured using an example microcontroller 206 configured for high-speed data acquisition using a strain gauge 202. The microcontroller 206 can be configured as a small-footprint PCB. The strain gauge 202 can be operably coupled to an amplifier and conditioner circuit 204, and then to the microcontroller 206. A battery 208 can be used to power any or all of the strain gauge 202, amplifier and conditioner circuit 204, and/or microcontroller 206 as shown in FIG. 2A. FIG. 2B illustrates a system using a slip ring 210 for power as an alternative to a battery.

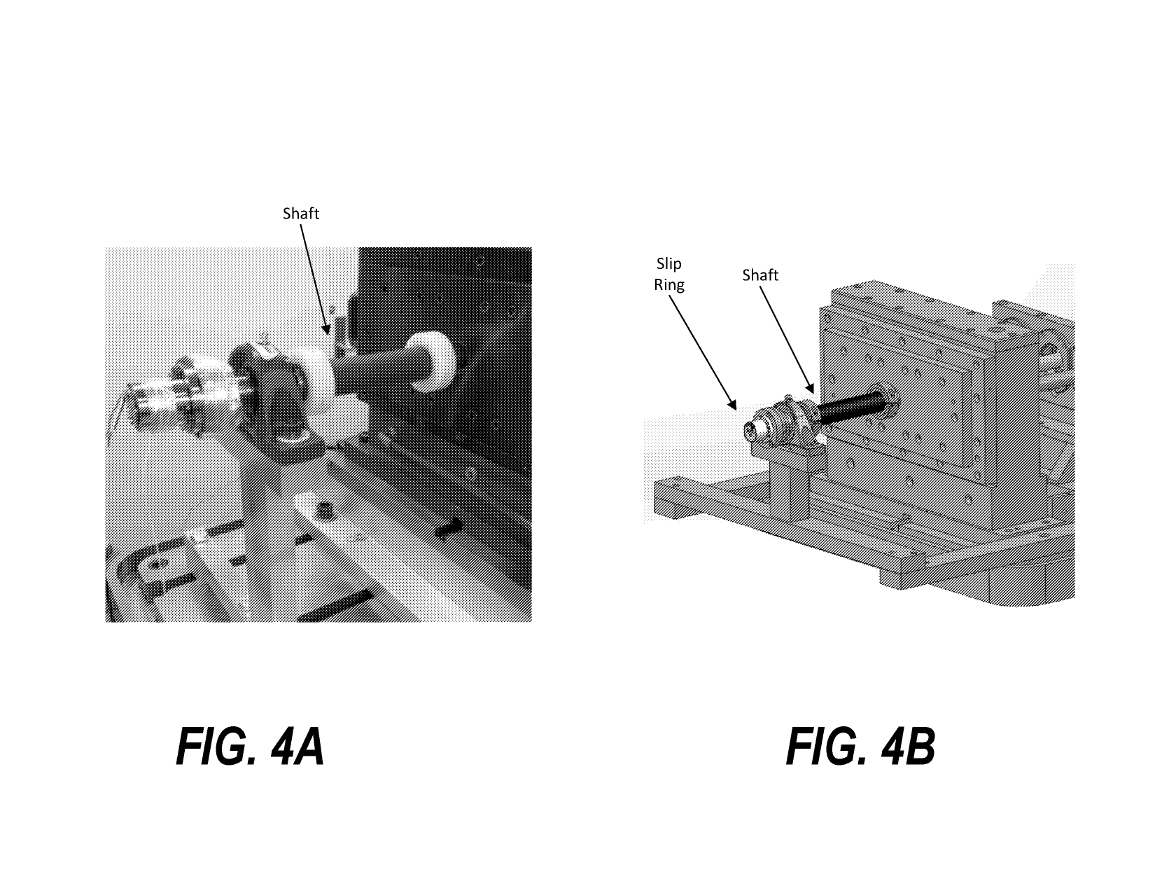

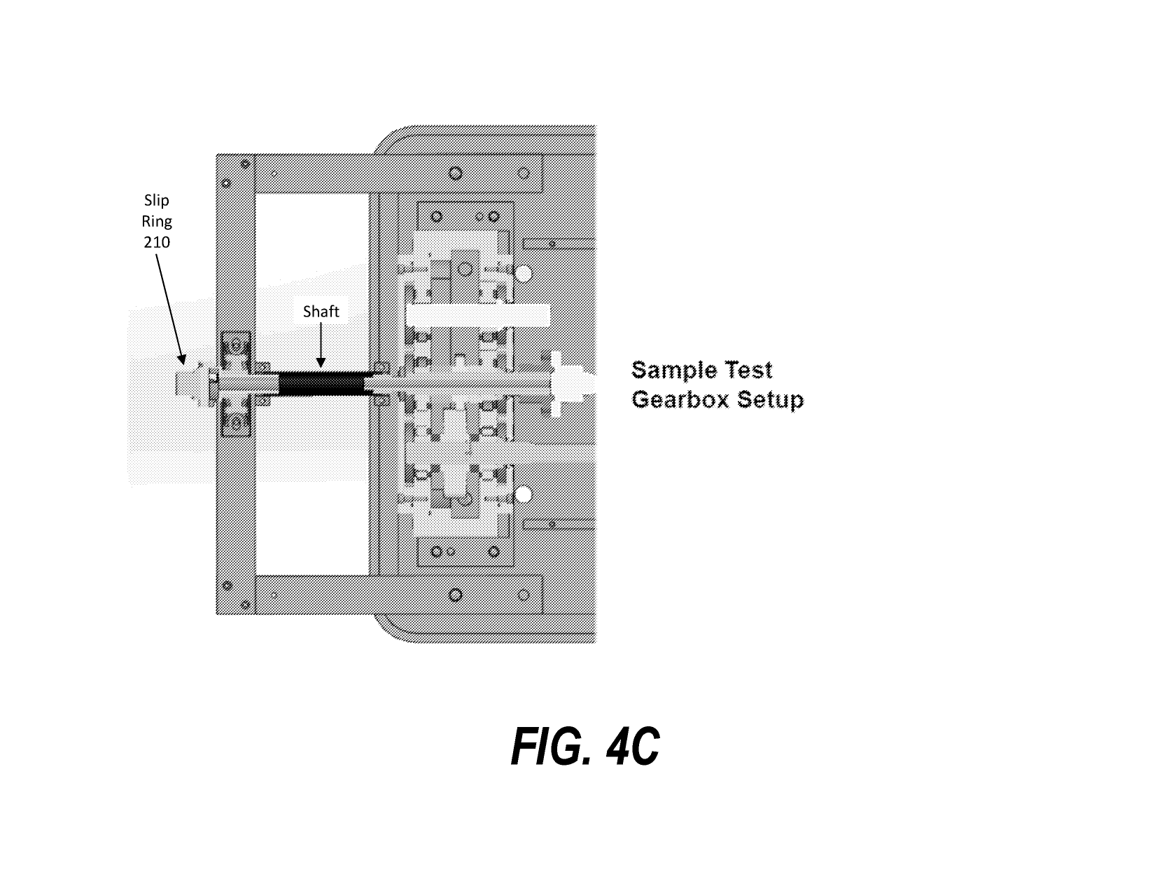

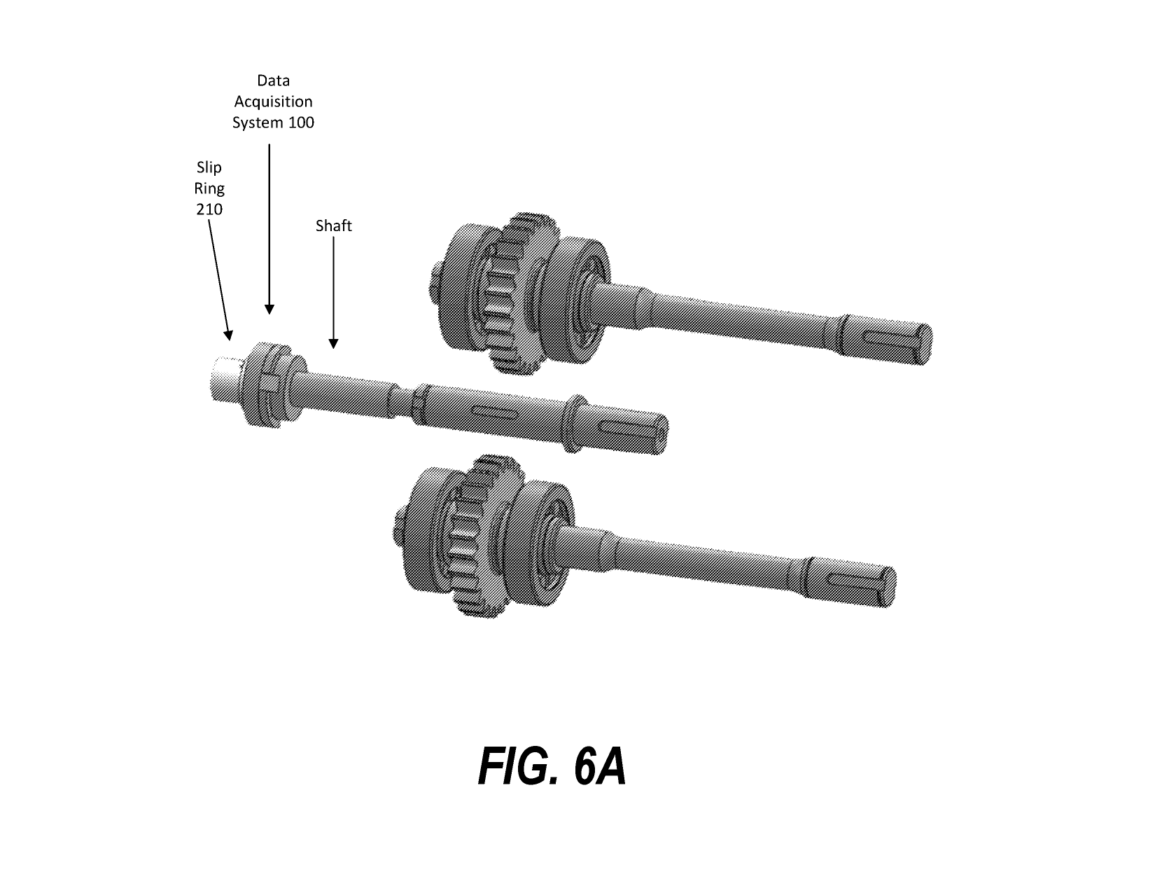

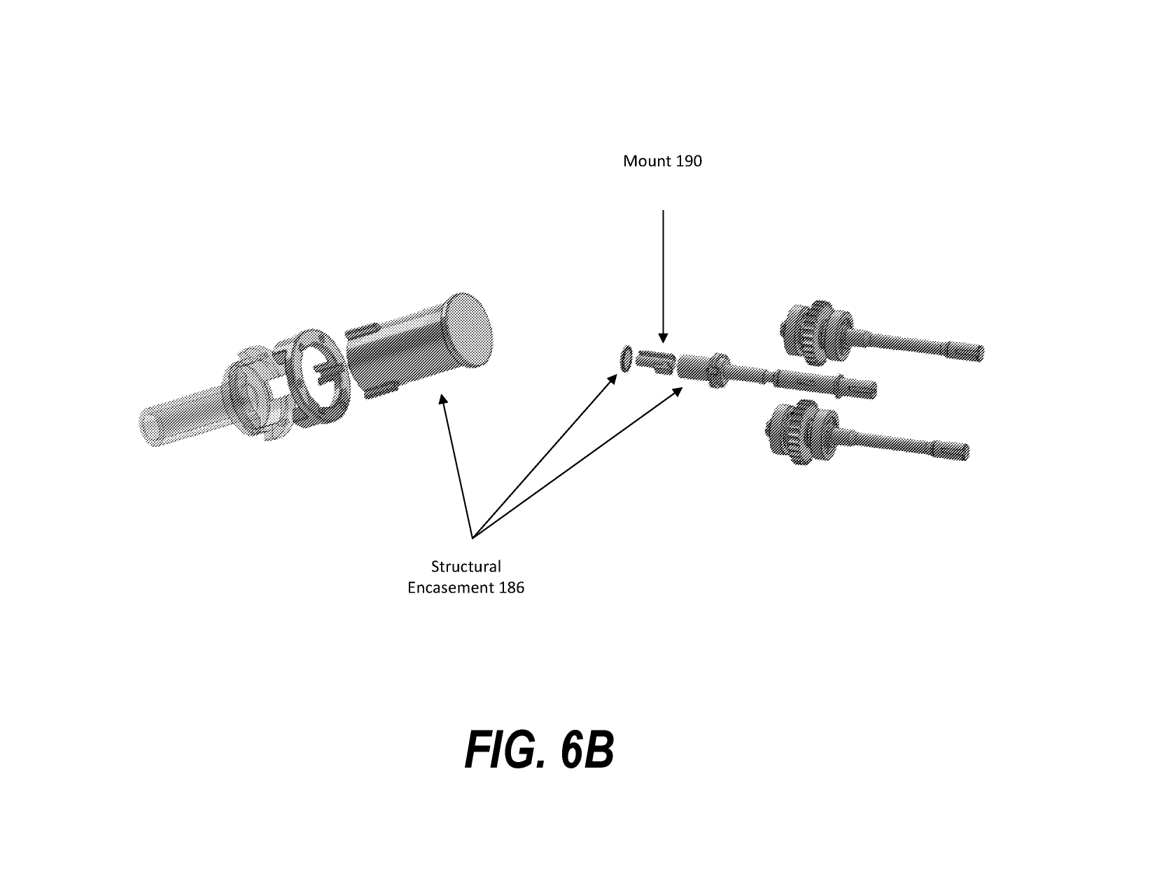

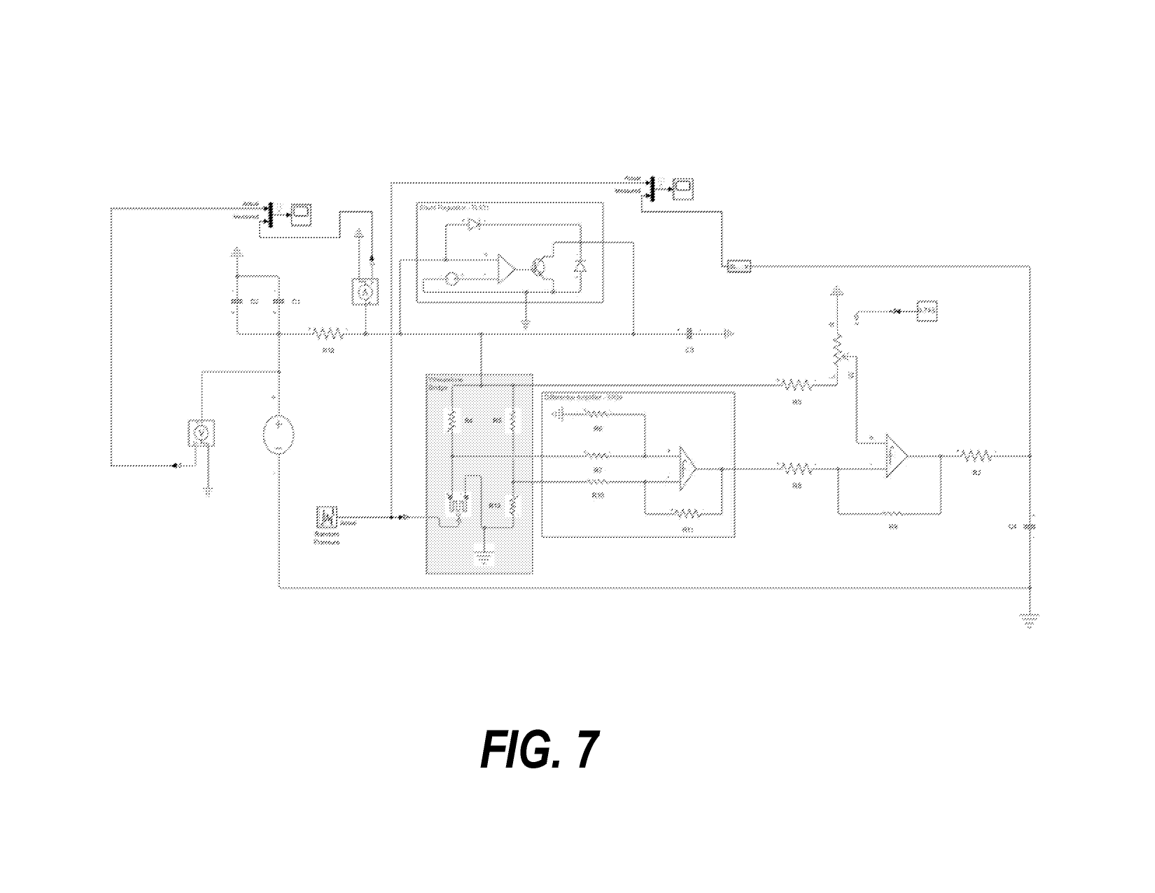

FIGS. 4A-4C illustrate example views of a test gearbox used in a study of implementations of the present disclosure. The perspective view shown in FIG. 4A, schematic view shown in FIG. 4B, and cross-sectional view shown in FIG. 4C each show a shaft with a slip ring 210. The data acquisition system 100 shown in FIGS. 1A-1C can be positioned on the shaft, as shown in greater detail in FIGS. 1D and 6A-6B, for example.

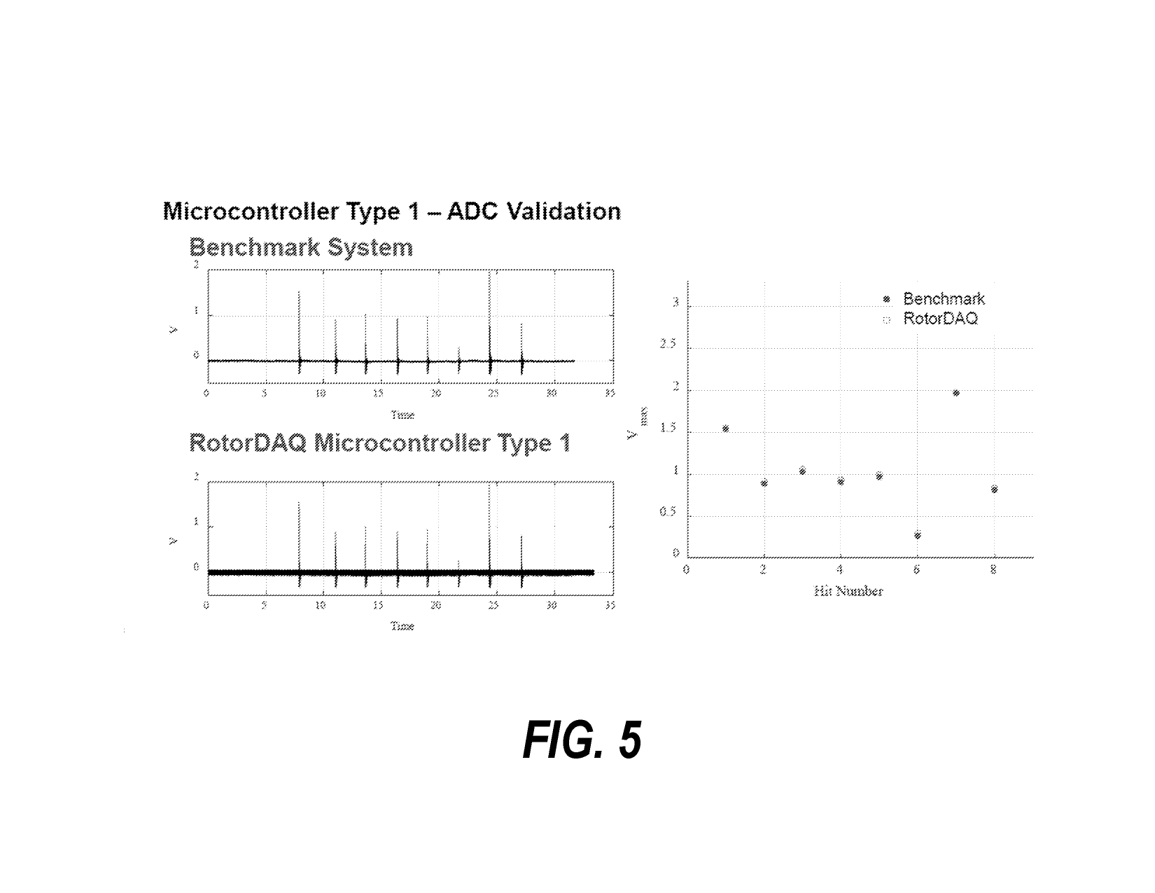

FIG. 5 illustrates example results from a study that was performed comparing an example implementation of the present disclosure to a conventional “benchmark” system. The plots compare the voltage measured by the benchmark system and the example implementation described herein (referred to as RotorDAQ). The results for RotorDAQ and the benchmark circuit agree, showing that implementations of the present disclosure enable measurements to be recorded on the rotating shaft with simpler and cheaper hardware than the conventional benchmark system.

FIG. 6A illustrates an example assembly including a slip ring 210 and data acquisition system 100 mounted to a shaft. As described with reference to FIG. 1A, power and/or data can be transmitted from the data acquisition system 100 through the slip ring 210. Alternatively or additionally, the system may not include a slip ring 210 as shown in FIG. 6B, or the slip ring may not be used, and the data acquisition system 100 can either wirelessly transmit data and/or store data in a memory 112 of the microcontroller 110 as described with reference to FIG. 1A.

As used herein, the terms "about" or "approximately" when referring to a measurable value such as an amount, a percentage, and the like, is meant to encompass variations of ±20%, ±10%, ±5%, or ±1% from the measurable value.

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by box 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

WHAT IS CLAIMED:

1. A data acquisition system comprising:
a microcontroller; and
a first sensor operably coupled to the microcontroller; wherein the first sensor and the microcontroller are configured to be fixed to a rotating machine, and wherein the microcontroller is configured to record sensor data from the first sensor during the operation of the rotating machine.

2. The data acquisition system of claim 1, further comprising an amplifier operably coupled between the first sensor and the microcontroller.

3. The data acquisition system of claim 1, further comprising a conditioner operably coupled between the first sensor and the microcontroller.

4. The data acquisition system of claim 3, wherein the conditioner comprises an analog strain conditioner.

5. The data acquisition system of claim 1, further comprising an LED operably coupled to the microcontroller, wherein the microcontroller is configured to control the LED based on the sensor data.

6. The data acquisition system of claim 1, wherein the microcontroller comprises an analog-to-digital converter configured to sample an output of the first sensor.

7. The data acquisition system of claim 6, wherein the analog-to-digital converter is configured to sample the output of the first sensor at a rate of 350,000 samples per second or greater.

8. The data acquisition system of claim 1, further comprising a second sensor operably coupled to the microcontroller.

9. The data acquisition system of claim 8, wherein the microcontroller comprises a dual-channel ADC with a first channel and a second channel, and wherein the first channel is operably coupled to the first sensor and the second channel is operably coupled to the second sensor.

10. The data acquisition system of claim 9, wherein the dual-channel ADC is configured to simultaneously sample both the first channel and second channel at a rate of 300,000 samples per second or greater.

11. The data acquisition system of claim 8, wherein the first sensor or the second sensor comprise a strain gauge.

12. The data acquisition system of claim 8, wherein the first sensor or the second sensor comprise an analog strain gauge.

13. The data acquisition system of claim 8, wherein the first sensor or the second sensor comprise a thermocouple.

14. The data acquisition system of claim 8, wherein the first sensor or the second sensor comprise a MEMS accelerometer or a piezoelectric sensor.

15. The data acquisition system of claim 1, further comprising a removable memory operably coupled to the microcontroller.

16. The data acquisition system of claim 1, further comprising a package covering at least a part of the microcontroller and configured to affix the microcontroller to the rotating machine.

17. The data acquisition system of claim 16, wherein the package is configured to cool the microcontroller.

18. The data acquisition system of claim 1, wherein the microcontroller is configured to adjust a sampling rate, and/or recording rate of the data acquisition system based on a temperature of the microcontroller and/or a speed of the rotating machine.

19. A system comprising:
a microcontroller; and
a remote computing device;
a first sensor operably coupled to the microcontroller; wherein the first sensor and the microcontroller are configured to be fixed to a rotating machine, and wherein the microcontroller is in operative communication with the remote computing device and configured to transmit sensor data from the first sensor during the operation of the rotating machine.

20. The system of claim 19, further comprising a slip ring coupling the remote computing device and the microcontroller.
